(19) United States
(12) Patent Application Publication
(10) Pub. No.: US 2012/0132348 A1
(43) Pub. Date: May 31, 2012

(54) METHOD FOR MANUFACTURING LIQUID CRYSTAL DISPLAY DEVICE

(75) Inventors: Daisuke Kubota, Isehara (JP); Akio Yamashita, Atsugi (JP); Masaru Nakano, Isehara (JP)

(73) Assignee: SEMICONDUCTOR ENERGY LABORATORY CO., LTD., Atsugi-shi (JP)

(21) Appl. No.: 13/301,897

(22) Filed: Nov. 22, 2011

(30) Foreign Application Priority Data
Nov. 30, 2010 (JP) 2010-267309

(51) Int. Cl. B32B 37/14; B32B 37/02

(52) U.S. Cl. 156/145

(57) ABSTRACT

A liquid crystal layer including a polymerizable monomer and a liquid crystal composition exhibiting a blue phase is provided between a first substrate and a second substrate which are bonded to each other with a sealant. Further, the sealant and part of the liquid crystal layer are covered by a light shield and a first light irradiation treatment is performed on the liquid crystal layer with use of the light shield as a mask, whereby a first region in which the polymerizable monomer is polymerized is formed. Furthermore, a second light irradiation treatment is performed on the liquid crystal layer after the light shield is removed, whereby a second region having a lower degree of polymerization of the polymerizable monomer than the first region is formed.

### BACKGROUND OF THE INVENTION

1. Field of the Invention

The present invention relates to a method for manufacturing a liquid crystal display device.

2. Description of the Related Art

As a display device which is thin and lightweight (a so-called flat panel display), a liquid crystal display device including a liquid crystal element, a light-emitting device including a self light-emitting element, a field emission display (an FED), and the like have been competitively developed.

In a liquid crystal display device, response speed of liquid crystal molecules is required to be increased. A display mode of liquid crystal has a variety of types, and among them, a ferroelectric liquid crystal (FLC) mode, an optical compensated bend (OCB) mode, and a mode using liquid crystal exhibiting a blue phase can be given as liquid crystal modes capable of high-speed response.

In particular, the mode using a liquid crystal exhibiting a blue phase does not require an alignment film and the viewing angle can be widened; therefore, further research thereon has been carried out for practical use (see Patent Document 1, for example). Patent Document 1 reports that a liquid crystal is subjected to polymer stabilization treatment so that the temperature range where a blue phase is exhibited is increased.

### REFERENCE

[Patent Document 1] PCT International Publication No. 05/090520

### SUMMARY OF THE INVENTION

Polymer stabilization treatment is treatment performed in such a manner that light or heat is given to a liquid crystal layer which is formed by adding a polymerizable monomer to a liquid crystal composition exhibiting a blue phase, whereby the polymerizable monomer is polymerized so that the blue phase is stabilized. However, it is difficult to polymerize the polymerizable monomer uniformly in a large-sized substrate surface. Further, internal stress due to distortions by hardening and shrinking is generated at the time of polymerization of the polymerizable monomer. By nonuniform polymerization of the polymerizable monomer and generation of internal stress in the liquid crystal layer, an alignment state of the liquid crystal composition also becomes nonuniform and a stable blue phase cannot be formed. Accordingly, a problem is caused in that display quality and reliability of a liquid crystal display device is reduced.

Therefore, it is an object to provide a highly reliable liquid crystal display device which includes a liquid crystal layer exhibiting a more stable blue phase and a method for manufacturing the liquid crystal display device.

One embodiment of the present invention is a method for manufacturing a liquid crystal display device in which a liquid crystal layer including a polymerizable monomer and a liquid crystal composition exhibiting a blue phase is provided between a first substrate and a second substrate which are bonded to each other with a sealant; and the sealant and part of the liquid crystal layer are covered by a light shield. Further, first light irradiation treatment is performed on the liquid crystal layer with use of the light shield as a mask, whereby a first region in which the polymerizable monomer is polymerized is formed; and second light irradiation treatment is performed on the liquid crystal layer after the light shield is removed, whereby a second region having a lower degree of polymerization of the polymerizable monomer than the first region is formed. Note that the liquid crystal composition exhibiting a blue phase includes a liquid crystal material exhibiting a blue phase and a chiral agent.

Further, one embodiment of the present invention is a method for manufacturing a liquid crystal display device in which a liquid crystal layer including a polymerizable monomer and a liquid crystal composition exhibiting a blue phase is provided between a first substrate and a second substrate which are bonded to each other with a sealant; and the sealant and part of the liquid crystal layer are covered by a light shield. Further, first light irradiation treatment is performed on the liquid crystal layer with use of the light shield as a mask, whereby a first region in which the polymerizable monomer is polymerized is formed; and second light irradiation treatment is performed on the sealant and the liquid crystal layer after the light shield is removed, whereby a second region having a lower degree of polymerization of the polymerizable monomer than the first region is formed and the sealant is cured.

Further, one embodiment of the present invention is a method for manufacturing a liquid crystal display device in which a liquid crystal layer including a polymerizable monomer and a liquid crystal composition exhibiting a blue phase is provided between a first substrate and a second substrate which are bonded to each other with a sealant; and the sealant and part of the liquid crystal layer are covered by a first light shield. Further, first light irradiation treatment is performed on the liquid crystal layer with use of the first light shield as a mask, whereby a first region in which the polymerizable monomer is polymerized is formed. Furthermore, the first region is covered by a second light shield after the first light shield is removed; and second light irradiation treatment is performed on the liquid crystal layer with use of the second light shield as a mask, whereby a second region having a lower degree of polymerization of the polymerizable monomer than the first region is formed.

Further, one embodiment of the present invention is a method for manufacturing a liquid crystal display device in which a light shield is formed in a peripheral portion of a first substrate or a second substrate; and a liquid crystal layer including a polymerizable monomer and a liquid crystal composition exhibiting a blue phase is provided between the first substrate and the second substrate which are bonded to each other with a sealant. Further, first light irradiation treatment is performed on the liquid crystal layer from the first substrate side or the second substrate side on which the light shield is formed, whereby a first region in which the polymerizable monomer is polymerized is formed. Furthermore, second light irradiation treatment is performed on the sealant and the liquid crystal layer from the first substrate side or the second substrate side on which the light shield is not formed, whereby a second region having a lower degree of polymerization of the polymerizable monomer than the first region is formed. Note that the peripheral portion of the first substrate or the second substrate is a region of the sealant and part of the liquid crystal layer (the vicinity of the sealant).

Further, in the above structure, an ultraviolet curable resin or a photocurable and thermosetting resin can be used for the sealant. The second light irradiation treatment is performed with the use of an ultraviolet curable resin or a photocurable and thermosetting resin, whereby the second region having a lower degree of polymerization of the polymerizable monomer than the first region can be formed, and in addition, the sealant can be cured. In addition, as the sealant formed of the ultraviolet curable resin, an acrylic-based resin, an epoxy-based resin, or an amine resin can be used, and as the sealant formed of a photocurable and thermosetting resin, a resin in which an acrylic-based resin and an epoxy-based resin are mixed can be used. Note that a visible light curable resin or a thermosetting resin can be used.

Further, in the above structure, it is preferable that a display region of a liquid crystal display device be formed in the first region of the liquid crystal layer.

Note that the ordinal numbers such as “first” and “second” in this specification are used for convenience and do not denote the order of steps and the stacking order of layers. In addition, the ordinal numbers in this specification do not denote particular names which specify the present invention.

According to one embodiment of the present invention, a highly reliable liquid crystal display device which includes a liquid crystal layer exhibiting a stable blue phase can be manufactured.

### BRIEF DESCRIPTION OF THE DRAWINGS

FIGS. 1A and 1B illustrate a liquid crystal display device.

FIGS. 2A1, 2A2, 2B1, 2B2, 2C1, and 2C2 illustrate a method for manufacturing a liquid crystal display device.

FIGS. 3A1, 3A2, 3B1, and 3B2 illustrate a method for manufacturing a liquid crystal display device.

FIGS. 4A1, 4A2, 4B1, 4B2, 4C1, and 4C2 illustrate a method for manufacturing a liquid crystal display device.

FIGS. 5A to 5C illustrate a method for manufacturing a liquid crystal display device.

FIGS. 6A to 6C illustrate a method for manufacturing a liquid crystal display device.

FIGS. 7A to 7C each illustrate a method for manufacturing a liquid crystal display device.

FIGS. 8A1, 8A2, and 8B each illustrate a liquid crystal display device.

FIG. 9 illustrates a liquid crystal display module.

FIGS. 10A and 10B illustrate an electronic appliance.

FIGS. 11A to 11F each illustrate an electronic appliance.

FIGS. 12A to 12F illustrate a method for manufacturing a liquid crystal display device.

FIGS. 13A and 13B are each a photograph showing an appearance of a liquid crystal display device.

### DETAILED DESCRIPTION OF THE INVENTION

Embodiments will be described in detail with reference to the drawings. However, the present invention is not limited to the following description, and various changes for the modes and details thereof will be apparent to those skilled in the art unless such changes depart from the spirit and the scope of the invention. Therefore, the present invention should not be construed as being limited to the following description of the embodiments. In the structures to be given below, the same portions or portions having similar functions are denoted by the same reference numerals in different drawings, and explanation thereof will not be repeated.

### Embodiment 1

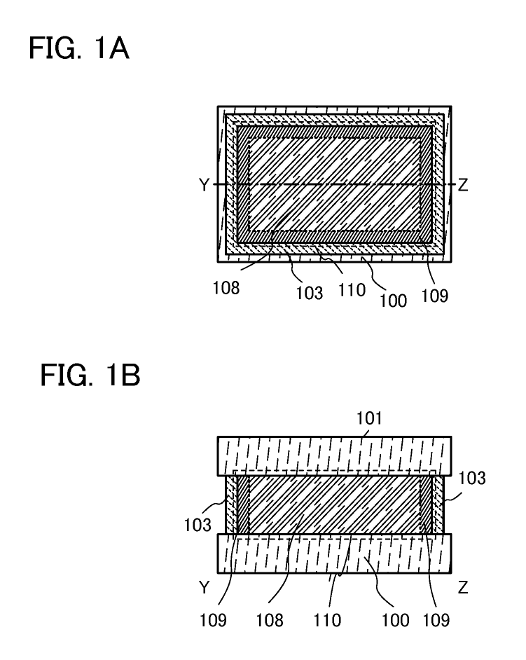

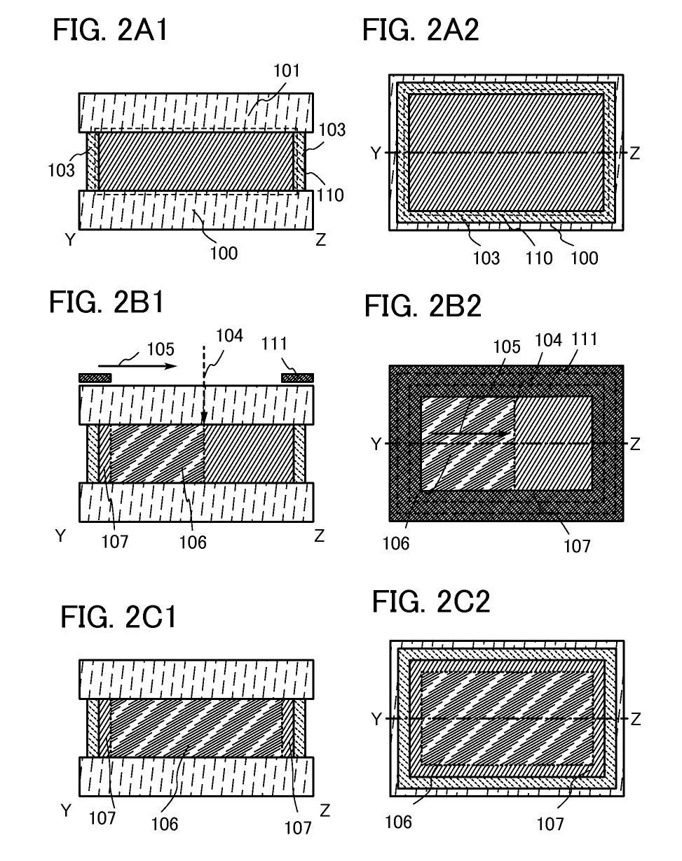

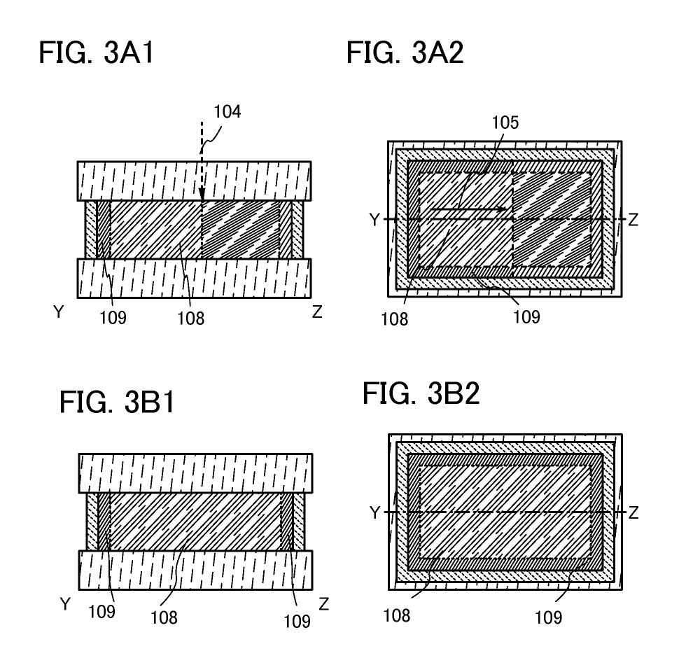

A liquid crystal display device according to one embodiment of the present invention will be described with reference to FIGS. 1A and 1B, FIGS. 2A1, 2A2, 2B1, 2B2, 2C1, and 2C2, and FIGS. 3A1, 3A2, 3B1, and 3B2.

FIG. 1A illustrates a plan view of a liquid crystal display device, and FIG. 1B is a cross-sectional view taken along line Y-Z in FIG. 1A.

In a liquid crystal display device according to one embodiment of the present invention, a first substrate 100 and a second substrate 101 (not illustrated in FIG. 1A) are bonded (attached) to each other by a sealant 103. A liquid crystal layer 110 is provided between the first substrate 100 and the second substrate 101. Note that the sealant 103 is provided so as to surround the liquid crystal layer 110. The liquid crystal layer 110 includes a polymerizable monomer and a liquid crystal composition exhibiting a blue phase. Further, the liquid crystal layer 110 includes a first region 108 and a second region 109.

Next, a method for manufacturing a liquid crystal display device according to one embodiment of the present invention will be described with reference to FIGS. 2A1, 2A2, 2B1, 2B2, 2C1, and 2C2 and FIGS. 3A1, 3A2, 3B1, and 3B2.

FIGS. 2A2, 2B2, and 2C2 and FIGS. 3A2 and 3B2 are plan views of the liquid crystal display device. FIGS. 2A1, 2B1, and 2C1 and FIGS. 3A1 and 3B1 are cross-sectional views taken along line Y-Z in FIGS. 2A2, 2B2, and 2C2 and FIGS. 3A2 and 3B2, respectively.

The first substrate 100 and the second substrate 101 are bonded to each other by the sealant 103. The liquid crystal layer 110 is provided between the first substrate 100 and the second substrate 101 (see FIGS. 2A1 and 2A2). The sealant 103 is provided so as to surround the liquid crystal layer 110. The liquid crystal layer 110 includes a polymerizable monomer and a liquid crystal composition exhibiting a blue phase. The liquid crystal composition exhibiting a blue phase is capable of high-speed response; thus, a high-performance liquid crystal display device can be achieved.

As the first substrate 100 and the second substrate 101, a glass substrate made of barium borosilicate glass, aluminoborosilicate glass, or the like, a quartz substrate, or a flexible substrate such as a plastic substrate can be used.

As the sealant 103, it is typically preferable to use a visible light curable resin, an ultraviolet curable resin, a thermosetting resin, or a photocurable and thermosetting resin. As the visible light curable resin, the ultraviolet curable resin, or the thermosetting resin, typically, an acrylic resin, an epoxy resin, an amine resin, or the like can be used. As the photocurable and thermosetting resin, a resin in which an acrylic-based resin and an epoxy-based resin are mixed can be used. Further, the sealant 103 is applied to the first substrate 100 or the second substrate 101 by a screen printing method, a dispenser method (a dropping method), or an ink-jet method. Note that the sealant 103 may include a filler (1 μm to 24 μm in diameter) to keep a space between the first substrate 100 and the second substrate 101, a photopolymerization initiator (typically, an ultraviolet light polymerization initiator), a thermosetting agent, a coupling agent, or the like.

The liquid crystal layer 110 can be formed by a dispenser method (a dropping method), or an injecting method by which the liquid crystal composition and the polymerizable monomer are injected using a capillary injection method or a vacuum injection method after the first substrate 100 and the second substrate 101 are bonded to each other.

The liquid crystal composition exhibiting a blue phase includes a liquid crystal material exhibiting a blue phase and a chiral agent.

As the liquid crystal material exhibiting a blue phase, thermotropic liquid crystal, low-molecular liquid crystal, high-molecular liquid crystal, ferroelectric liquid crystal, anti-ferroelectric liquid crystal, or the like can be used.

The chiral agent is used so that liquid crystal molecules exhibiting a blue phase are induced to twist and are aligned to form a helical structure and to exhibit a blue phase. For example, the liquid crystal material exhibiting a blue phase included in the liquid crystal layer 110, into which a chiral agent is mixed at several weight percent or more can be used for the liquid crystal layer 110. Further, as the chiral agent, a compound having an asymmetric center, a high compatibility with a liquid crystal material exhibiting a blue phase, and a strong twisting power is used. In addition, the chiral agent is an optically active substance; a higher optical purity is better and the most preferable optical purity is 99% or higher.

A blue phase is exhibited when a liquid crystal material having a strong twisting power is used and has a double twist structure. The liquid crystal material exhibits a cholesteric phase, a cholesteric blue phase, an isotropic phase, or the like depending on conditions.

The cholesteric blue phase which is a blue phase shows three structures of a blue phase I, a blue phase II, and a blue phase III from the low temperature side. The cholesteric blue phase which is a blue phase is optically isotropic; however, the blue phase I has body-centered cubic symmetry, the blue phase II has simple cubic symmetry, and the blue phase III has isotropic symmetry. The blue phase I and the blue phase II exhibit Bragg diffraction in an ultraviolet region to a visible region.

A blue phase has a three-dimensional molecular orientation having a double twist structure and a line defect existing therein. The liquid crystal composition exhibiting a blue phase has an optical modulation action and is optically isotropic under the state of applying no voltage; however, the liquid crystal composition becomes optically anisotropic through a change in alignment order of the liquid crystal composition by voltage application. A blue phase is optically isotropic under the state of applying no voltage and thus has no viewing angle dependence. Thus, an alignment film is not necessarily formed; therefore, display image quality can be improved and cost can be reduced.

Since thermodynamic stability of a blue phase is reduced due to a line defect in the three-dimensional molecular orientation having a double twist structure, the temperature range in which a blue phase is exhibited is as extremely narrow as about 1° C. In order to improve such a temperature range, a polymerizable monomer is added to a liquid crystal material exhibiting a blue phase, and polymer stabilization treatment is performed. As the polymerizable monomer, for example, a thermopolymerizable (a thermosetting) monomer which can be polymerized by heat, a photopolymerizable (a photocurable) monomer which can be polymerized by light, or a polymerizable monomer which can be polymerized by heat and light can be used. Alternatively, a polymerization initiator may be added to a liquid crystal material exhibiting a blue phase.

The polymerizable monomer may be a monofunctional monomer such as acrylate or methacrylate; a polyfunctional monomer such as diacrylate, triacrylate, dimethacrylate, or trimethacrylate; or a mixture thereof. Further, the polymerizable monomer may have liquid crystallinity, non-liquid crystallinity, or both of them.

The polymerization initiator may be a radical polymerization initiator which generates a radical by light irradiation, an acid generator which generates acid by light irradiation, or a base generator which generates a base by light irradiation.

Note that the polymerizable monomer whose polymerization has progressed by polymer stabilization treatment is included in a liquid crystal layer as a polymer.

For example, the polymerizable monomer and the photopolymerization initiator are added to the liquid crystal composition exhibiting a blue phase as described above and irradiation with light having a wavelength with which the polymerizable monomer and the photopolymerization initiator react is performed, whereby polymer stabilization treatment can be performed. As the polymerizable monomer, typically, a UV polymerizable monomer can be used. When the UV polymerizable monomer is used as the polymerizable monomer, the liquid crystal composition is irradiated with an ultraviolet light.

The polymer stabilization treatment may be performed by irradiating a liquid crystal layer at a temperature exhibiting an isotropic phase with light or by irradiating a liquid crystal layer exhibiting a blue phase under the control of the temperature with light. As an example of the polymer stabilization treatment, after the liquid crystal layer 110 is heated to exhibit an isotropic phase, the temperature of the liquid crystal layer 110 can be gradually decreased so that the phase transfers to a blue phase, and then, light irradiation is performed while the temperature at which the blue phase is exhibited is kept. Alternatively, after the phase changes to an isotropic phase by heating the liquid crystal layer 110, the liquid crystal layer is irradiated with light at a temperature within +10° C., preferably +5° C. from the phase transition temperature between the blue phase and the isotropic phase (with an isotropic phase exhibited). Without exhibition of a blue phase, polymer stabilization treatment may be performed by irradiation with light at a temperature within +10° C., preferably +5° C. from the phase transition temperature between the blue phase and the isotropic phase (with an isotropic phase exhibited). The phase transition temperature between the blue phase and the isotropic phase is a temperature at which the phase changes from the blue phase to the isotropic phase when the temperature rises, or a temperature at which the phase changes from the isotropic phase to the blue phase when the temperature decreases.

When the liquid crystal layer 110 is irradiated with light in a state where the temperature at which a blue phase exhibits (or a blue phase is made to exhibit) is kept, the polymerizable monomer is polymerized; thus, an alignment state of the liquid crystal composition exhibiting a blue phase is maintained. Accordingly, a state of the blue phase is stabilized and a temperature range in which the blue phase can be applied to the liquid crystal layer 110 can be largely improved (for example, the temperature range can become greater than or equal to 40° C.).

Here, a first region 106 of the liquid crystal layer is a display region of a liquid crystal display device; therefore, it is preferable that polymerization of the polymerizable monomer be uniformly performed in the first region 106. When polymerization of the polymerizable monomer is not uniform, an alignment state of the liquid crystal composition exhibiting a blue phase also becomes nonuniform and a stable blue phase cannot be formed. Further, the polymerizable monomer included in the liquid crystal layer 110 hardens and shrinks at the time of polymerization; therefore, internal stress due to distortions is generated in the liquid crystal layer 110. Such internal stress becomes more apparent as the degree of polymerization of the polymerizable monomer increases. In addition, internal stress changes depending on the degree of polymerization. By generation of such internal stress in the liquid crystal layer 110, an alignment state of the liquid crystal composition exhibiting a blue phase becomes nonuniform and a stable blue phase cannot be formed. Further, in the vicinity of the sealant 103, the liquid crystal layer 110 is easily affected by internal stress due to distortions; thus, an alignment state of the liquid crystal composition exhibiting a blue phase easily becomes nonuniform. Accordingly, display quality of the display region is decreased, whereby a problem of reduction in reliability of the liquid crystal display device is caused.

In view of the above, in this embodiment, two-step light irradiation treatment is performed on the liquid crystal layer 110 as the polymer stabilization treatment. In first light irradiation treatment, the sealant 103 and part (the vicinity of the sealant 103) of the liquid crystal layer 110 are covered by a light shield 111 and are shielded from light with the use of the light shield 111 as a mask, whereby the liquid crystal layer 110 is selectively irradiated with light. When the first light irradiation treatment is performed, in the liquid crystal layer 110, a region which is not covered with the light shield 111 is the first region 106 and a region which is covered with the light shield 111 is a second region 107.

The light shield 111 reflects or absorbs light 104; thus, the irradiation with the light 104 on the liquid crystal layer 110 (the second region) is blocked. It is preferable that the light shield 111 be provided to cover the sealant 103 and the vicinity of the sealant 103 in the liquid crystal layer 110. FIGS. 2B1 and 2B2 illustrate the case where the light shield 111 is provided over the second substrate 101. The light shield 111 may be a light-blocking member which is formed using a light-blocking material (for example, a metal material) and which covers the sealant 103 and part of the liquid crystal layer 110. Alternatively, the light shield 111 may be formed using a light-blocking material (for example, a metal material or a resist mask) over the second substrate 101. Further, the light shield 111 can be provided between the first substrate 100 and the sealant 103 or between the second substrate 101 and the sealant 103. In that case, it is preferable that after the light shield 111 is formed using a light-blocking material in a peripheral portion of the first substrate 100 or the second substrate 101, the first substrate 100 and the second substrate 101 are bonded to each other with the sealant so that the liquid crystal layer including a polymerizable monomer and a liquid crystal composition exhibiting a blue phase is interposed therebetween. Note that the peripheral portion of the first substrate or the second substrate is a region of the sealant and part of the liquid crystal layer (the vicinity of the sealant).

The first light irradiation treatment may be performed by irradiation with light to an entire surface of the first region 106 of the liquid crystal layer 110. Alternatively, the liquid crystal layer 110 may be scanned and irradiated with light processed into a linear shape in one direction. In FIGS. 2B1 and 2B2, the liquid crystal layer 110 is scanned and irradiated with the light 104 processed into a linear shape in the direction of an arrow 105, whereby polymerization of the polymerizable monomer proceeds from an irradiated region in the first region 106. Further, in the first light irradiation treatment, the sealant 103 and part of the liquid crystal layer 110 are shielded from light and the liquid crystal layer 110 is selectively irradiated with light; therefore, polymerization of the polymerizable monomer is not started in the second region 107 covered with the light shield 111. Note that in the first light irradiation treatment, polymerization of the polymerizable monomer is not necessarily finished in the first region 106.

FIGS. 2C1 and 2C2 illustrate a state in which the polymerizable monomer of the first region 106 is polymerized and the light shield 111 is removed.

In the first region 106 of the liquid crystal layer 110 which is not covered with the light shield 111, when polymerization of the polymerizable monomer progresses, internal stress due to distortions by hardening and shrinking is generated. Meanwhile, in the second region 107 of the liquid crystal layer 110 which is covered with the light shield 111, polymerization of the polymerizable monomer is not started; therefore, the second region 107 is kept in a liquid state having fluidity. Accordingly, even when internal stress due to distortions by hardening and shrinking is generated in the first region 106, the internal stress can be alleviated immediately by the second region having fluidity.

When the first light irradiation treatment is performed, the second region 107 of the liquid crystal layer 110 which is covered with the light shield 111 is not irradiated with light; therefore, polymerization is not started and the second region 107 has fluidity. Accordingly, the second region 107 having fluidity of the liquid crystal layer 110 enters the first region 106 in which the polymerizable monomer is polymerized of the liquid crystal layer 110, whereby orientation of the liquid crystal composition exhibiting a blue phase included in the first region 106 of the liquid crystal layer 110 might be disordered.

Therefore, it is preferable that a second light irradiation treatment be performed to an entire surface of the liquid crystal layer 110. The second light irradiation treatment is performed to an entire surface of the liquid crystal layer 110 after the first light irradiation treatment is performed and then the light shield 111 is removed. In the second light irradiation treatment, an entire surface of the liquid crystal layer 110 may be irradiated with light. Alternatively, the liquid crystal layer 110 may be scanned and irradiated with light processed into a linear shape in one direction. FIGS. 3A1 and 3A2 illustrate a state in which the liquid crystal layer 110 is scanned and irradiated with the light 104 processed into a linear shape in the direction of the arrow 105, whereby polymerization of the polymerizable monomer proceeds from an irradiation region of the second region 109 and the first region 108. By performing the second light irradiation treatment, the first region 106 becomes a first region 108 in which the degree of polymerization of the polymerizable monomer further increases and the second region 107 becomes a second region 109 in which polymerization of the polymerizable monomer is performed. Accordingly, polymerization of the polymerizable monomer can be progressed in the second region 107 which is covered with the light shield 111 and is not irradiated with light at the time of the first light irradiation treatment. It is preferable that polymerization of the polymerizable monomer be finished in the first region 106 by performing the second light irradiation treatment. Note that polymerization of the polymerizable monomer is not necessarily finished in the second region 107.

Further, in the case where the light shield 111 formed using a light-blocking material between the first substrate 100 and the sealant 103 or between the second substrate 101 and the sealant 103, the first substrate 100 or the second substrate 101, it is preferable that the first light irradiation treatment be performed from the side of the substrate on which the light shield 111 is formed and then the second light irradiation treatment be performed from the side of the substrate on which the light shield 111 is not formed.

FIGS. 3B1 and 3B2 illustrate a state in which the second light irradiation treatment is finished and then the polymer stabilization treatment of the liquid crystal layer 110 is finished.

As described above, even when internal stress due to distortions by hardening and shrinking of the polymerizable monomer is generated in the first region 106 in the first light irradiation treatment, the existence of the second region 107 having fluidity in the periphery of the first region 106 can immediately alleviate the internal stress generated in the first region 106. Further, in the second light irradiation treatment, the polymerizable monomer of the second region 107 is polymerized, whereby the liquid crystal material of the second region 109 after the second light irradiation treatment can be prevented from entering the liquid crystal material of the first region 108. Accordingly, alignment disorder of the liquid crystal composition exhibiting a blue phase in the first region 108 after the second light irradiation treatment can be suppressed. Thus, in the first region 108, a stable blue phase with a uniform alignment of the liquid crystal composition exhibiting a blue phase can be obtained. Further, by performing the light irradiation treatment while the liquid crystal layer is scanned relative to the light irradiation means, even a large-sized substrate can be treated. Thus, a stable blue phase with a uniform alignment of the liquid crystal composition exhibiting a blue phase can be obtained.

A display region (a pixel region) is formed in the first region 108 in which a stable blue phase is formed and the second region 109 is used for a driver circuit region or a region covered by a housing, which does not contribute to display. Accordingly, display quality of the display region is improved and a liquid crystal display device having higher reliability can be manufactured.

Note that in this embodiment, the case where an entire surface of the liquid crystal layer 110 is irradiated with light in the second light irradiation treatment is described; however, one embodiment of the present invention is not limited to this. For example, in the second light irradiation treatment, the first region 106 may be covered with a light shield having a light-blocking property and the second region 107 may be irradiated with light with the use of the light shield as a mask. Thus, the second region 109 having a lower degree of polymerization of the polymerizable monomer than the first region 108 can be formed. Further, by changing the condition of the light irradiation treatment as appropriate, the degree of polymerization of the polymerizable monomer of the first region 108 can be substantially the same as that of the polymerizable monomer of the second region 109. Note that when the first region 106 is covered with the light shield having a light-blocking property, it is preferable that the polymer stabilization treatment of the first region 106 be finished in the first light irradiation treatment. That is, it is preferable that polymerization of the polymerizable monomer progress up to approximately such an extent that the temperature range where the first region 106 can be used for the liquid crystal layer 110 as a blue phase is widened. In addition, the light shield is removed after the second light irradiation treatment.

For the liquid crystal layer 110 including the liquid crystal composition exhibiting a blue phase, for example, a mixture of JC-1041XX (produced by Chisso Corporation) and 4-cyano-4′-pentylbiphenyl can be used as the liquid crystal material exhibiting a blue phase. ZLI-4572 (produced by Merck Ltd., Japan) can be used as the chiral agent. As the polymerizable monomer, 2-ethylhexyl acrylate, RM257 (produced by Merck Ltd., Japan), or trimethylolpropane triacrylate can be used. As the photopolymerization initiator, 2,2-dimethoxy-2-phenylacetophenone can be used.

As the light irradiation means used for the first light irradiation treatment and the second light irradiation treatment, a UV lamp or the like can be used.

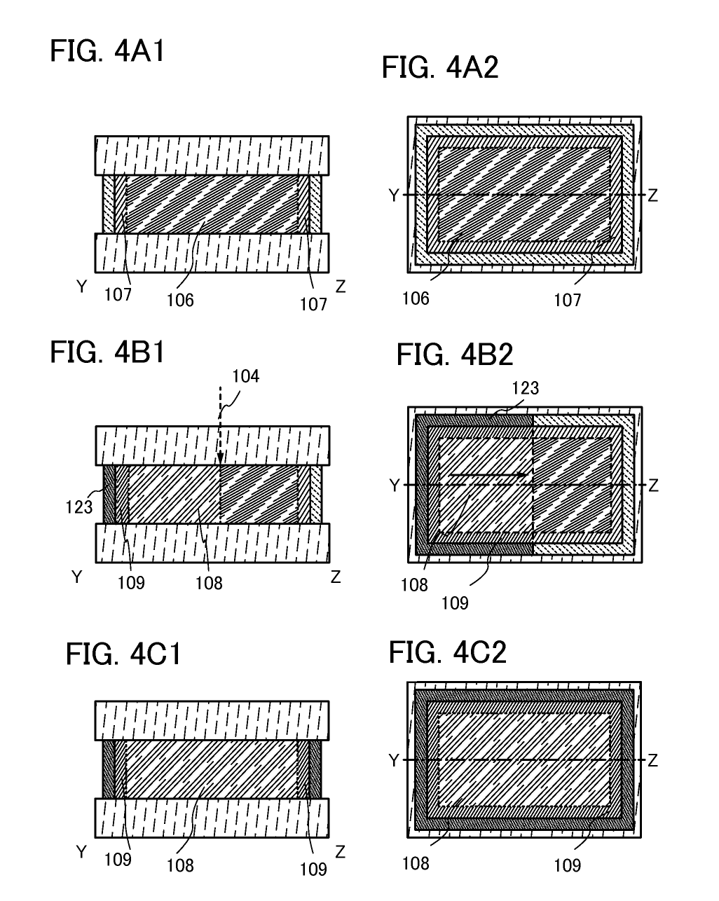

Further, for the sealant 103, an ultraviolet curable resin or a photocurable and thermosetting resin is used, whereby the polymerizable monomer of the second region 107 can be polymerized and the sealant 103 can be cured in the second light irradiation treatment. Description is given below with reference to FIGS. 4A1, 4A2, 4B1, 4B2, 4C1, and 4C2.

FIGS. 4A1 and 4A2 illustrate a cross-sectional view and a top view, respectively, of the liquid crystal layer 110 in a state after the first light irradiation treatment is finished and the light shield 111 is removed. As illustrated in FIGS. 4A1 and 4A2, the first region 106 and the second region 107 are formed in the liquid crystal layer 110.

Next, by performing the second light irradiation treatment, polymerization of the polymerizable monomer is performed in the first region 106 and the second region 107, and, in addition, the sealant 103 is cured and becomes a sealant 123 (see FIGS. 4B1 and 4B2). Note that in FIGS. 4B1 and 4B2, the case where the liquid crystal layer 110 is scanned and irradiated with the light processed into a linear shape in one direction in the second light irradiation treatment is described; however, one embodiment of the present invention is not limited to this. An entire surface of the liquid crystal layer 110 may be irradiated with light. Note that in the case where a photocurable and thermosetting resin is used as the sealant 103, it is preferable that heat treatment be performed after the second light irradiation treatment.

Since the polymerizable monomer of the second region 107 can be polymerized and the sealant 103 can be cured, the manufacturing process of the liquid crystal display device can be simplified (see FIGS. 4C1 and 4C2).

Further, in the case where the liquid crystal layer 110 is irradiated with the light processed into a linear shape in the first light irradiation treatment and the second light irradiation treatment, the linear light irradiation region may be formed by linearly arranging a plurality of light sources or by processing irradiation light from a light source with an optical system. Further, the shape of the light irradiation region with which the liquid crystal layer is irradiated may be rectangular, circular, elliptical, or the like instead of being linear. In addition, as the irradiation light, lamp light from a lamp light source, laser light from a laser light source, or the like can be used. Light having a wavelength and energy with which polymerization reaction of the polymerizable monomer occurs may be selected as appropriate. In the case where an ultraviolet curable resin (a UV curable resin) is used as the polymerizable monomer, for example, ultraviolet rays (light) may be used for the light irradiation treatment.

The light irradiation treatment is performed while the liquid crystal layer is scanned relative to the light irradiation means, whereby even a large-sized substrate can be treated. Thus, a uniform and stable blue phase can be obtained.

Moreover, although not illustrated in FIGS. 1A and 1B, FIGS. 2A1, 2A2, 2B1, 2B2, 2C1 and 2C2, FIGS. 3A1, 3A2, 3B1 and 3B2, and FIGS. 4A1, 4A2, 4B1, 4B2, 4C1 and 4C2, a polarizing plate and an optical film such as a retardation plate or an anti-reflection film are provided as appropriate. For example, circular polarization by the polarizing plate and the retardation plate may be used. In addition, a backlight, a side light, or the like may be used as a light source.

In the case where, in this specification and the like, the liquid crystal display device is a transmissive liquid crystal display device in which display is performed by transmission of light from a light source (or a semi-transmissive liquid crystal display device), it is necessary that light be transmitted at least in a pixel region. Therefore, the first substrate, the second substrate, and thin films such as an insulating film and a conductive film that exist in the pixel region through which the light passes all have a light-transmitting property with respect to light in a visible wavelength range.

In the above-described manner, a highly reliable liquid crystal display device which includes a liquid crystal layer exhibiting a stable blue phase can be manufactured.

### Embodiment 2

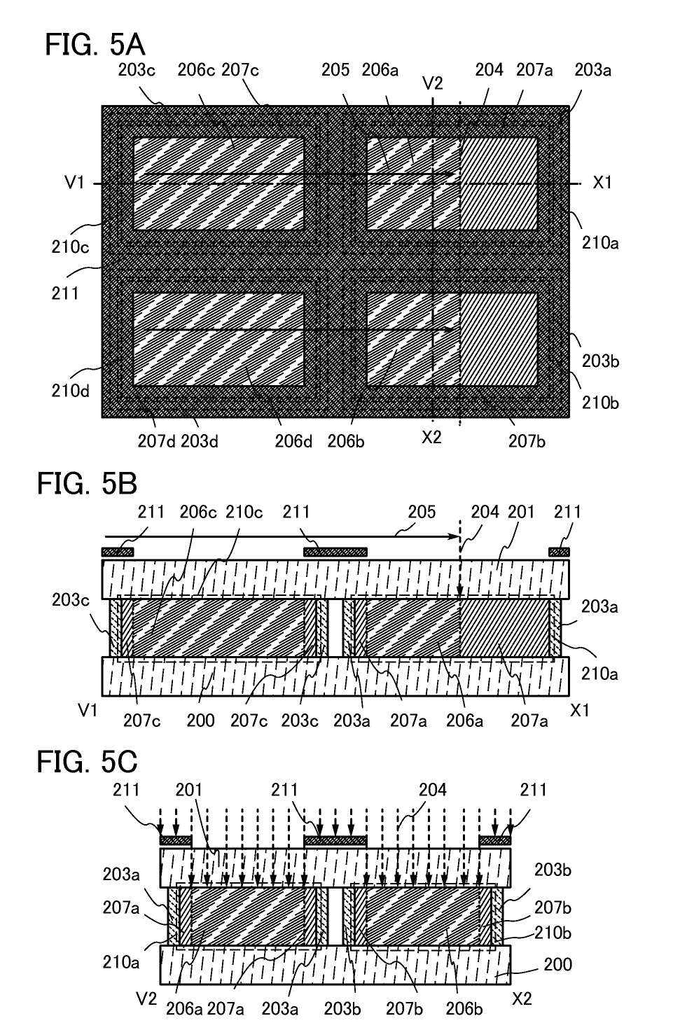

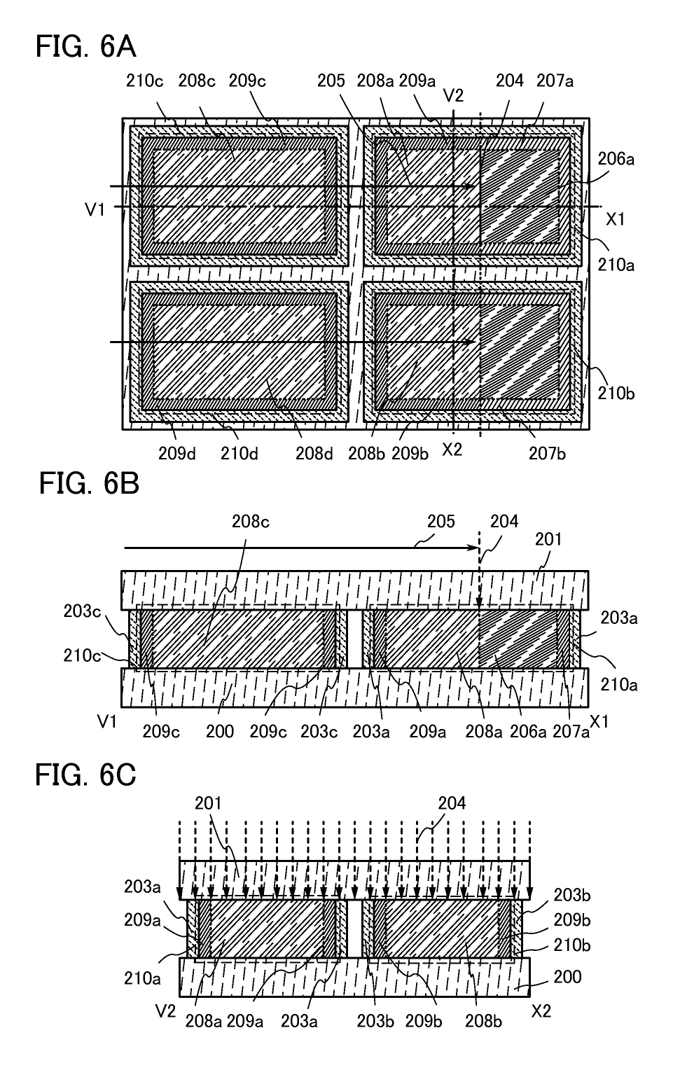

In this embodiment, an example of manufacturing a plurality of liquid crystal display devices over a large-sized substrate (a so-called multiple panel method) in Embodiment 1 will be described with reference to FIGS. 5A to 5C and FIGS. 6A to 6C. Therefore, part of this embodiment can be performed in a manner similar to that of Embodiment 1; thus, repetitive description of the same portions as or portions having functions similar to those in Embodiment 1 and steps for forming such portions will be omitted.

In the case of manufacturing a plurality of liquid crystal display devices using a large-sized substrate, a division step can be performed before the polymer stabilization treatment is performed or before the polarizing plates are provided. In consideration of the influence of the division step on a liquid crystal layer (such as alignment disorder of the liquid crystal composition due to force applied in the division step), it is preferable that the division step be performed after the bonding between a first substrate and a second substrate and before the polymer stabilization treatment.

FIGS. 5A to 5C illustrate a state where the first light irradiation treatment is performed on a plurality of liquid crystal layers. FIG. 5A is a plan view of a liquid crystal display device, FIG. 5B is a cross-sectional view taken along line V1-X1 in FIG. 5A, and FIG. 5C is a cross-sectional view taken along line V2-X2 in FIG. 5A.

In FIG. 5A, four liquid crystal layers 210a, 210b, 210c, and 210d are interposed between a first substrate 200 and a second substrate 201 which are bonded (attached) to each other, and arranged to be surrounded by sealants 203a, 203b, 203c, and 203d, respectively. The liquid crystal layers 210a, 210b, 210c, and 210d include a polymerizable monomer and a liquid crystal composition exhibiting a blue phase.

FIG. 5A illustrates a state where scanning with light 204 is performed in the direction of an arrow 205 with the use of a light shield 211 and polymerization of the polymerizable monomer is selectively performed on the plurality of the liquid crystal layers 210a, 210b, 210c, and 210d. Accordingly, first regions 206a, 206b, 206c, and 206d where polymerization of the polymerizable monomer is performed and second regions 207a, 207b, 207c, and 207d where polymerization of the polymerizable monomer is not performed can be formed.

FIG. 5B is a cross-sectional view taken along a surface parallel to an arrow 205 which indicates a scanning direction of the light 204. In the liquid crystal layers 210a and 210c, polymerization reaction proceeds in a region which is irradiated with the light 204 without being shielded from light by the light shield 211, so that the first regions 206a and 206c are formed. Meanwhile, in a region which is covered with the light shield 211 and is shielded from the light 204 or in a region which is not scanned by the light 204, light irradiation treatment is not performed, so that the second regions 207a and 207c are formed. In the liquid crystal layer 210c, the second region 207c is formed between the first region 206c and the sealant 203c. Similarly, in the liquid crystal layer 210a, the second region 207a is formed between the first region 206a and the sealant 203a.

FIG. 5C is a cross-sectional view taken along a surface perpendicular to the arrow 205 which indicates the scanning direction of the light 204. In the liquid crystal layers 210a and 210b, polymerization reaction proceeds in a region which is irradiated with the light 204 without being shielded from light by the light shield 211, so that the first regions 206a and 206b are formed. Meanwhile, in a region which is covered with the light shield 211 and is shielded from the light 204, light irradiation treatment is not performed, so that the second regions 207a and 207b are formed. In the liquid crystal layer 210a, the second region 207a is formed between the first region 206a and the sealant 203a. Similarly, in the liquid crystal layer 210b, the second region 207b is formed between the first region 206b and the sealant 203b.

In this manner, by combining the light shield 211 with the linear light 204 which is formed long in the direction of a side of the substrate, polymer stabilization treatment can be performed on the plurality of liquid crystal layers at one time; therefore, productivity can be increased. In addition, since the light irradiation treatment is performed in such a manner that the substrate is scanned relative to the light irradiation means, a large-sized light exposure apparatus is not necessary even for a large-sized substrate.

In this embodiment, an example in which the second regions 207a and 207b are formed in the liquid crystal layers 210a and 210b with the use of the light shield 211 as illustrated in FIG. 5C is described. However, the second regions 207a and 207b may be formed by controlling the shape of the light 204 so that the irradiation region does not reach the second regions 207a and 207b.

FIGS. 6A to 6C illustrate a state where the second light irradiation treatment is performed on the plurality of liquid crystal layers. FIG. 6A is a plan view of a liquid crystal display device, FIG. 6B is a cross-sectional view taken along line V1-X1 in FIG. 6A, and FIG. 6C is a cross-sectional view taken along line V2-X2 in FIG. 6A.

FIG. 6B is a cross-sectional view in a plane parallel to the arrow 205 which indicates a scanning direction of the light 204. In the liquid crystal layers 210a and 210c, polymerization reaction proceeds in a region which is irradiated with the light 204, so that the second regions 209a and 209c and the first regions 208a and 208c are formed. In the first regions 208a and 208c, polymerization of the polymerizable monomer is further enhanced by the second light irradiation treatment. In the second regions 209a and 209c, polymerization is started by the second light irradiation treatment.

Further, FIG. 6C is a cross-sectional view taken along a surface perpendicular to the arrow 205 which indicates the scanning direction of the light 204. In the liquid crystal layers 210a and 210b, polymerization reaction proceeds in a region which is irradiated with the light 204, so that the first regions 208a and 208b and the second regions 209a and 209b are formed.

The liquid crystal layers are scanned and irradiated with the light processed into a linear shape in one direction in the first light irradiation treatment and the second light irradiation treatment, whereby the polymerizable monomer can be uniformly polymerized even when a large substrate is employed. Accordingly, a plurality of liquid crystal display devices can be manufactured, which leads to a productivity improvement.

Note that a large-sized substrate is bent or warped in some cases. In this case, the substrate is placed vertically and is scanned with light, whereby light irradiation treatment can be performed uniformly.

Since the light irradiation treatment is performed while the liquid crystal layer is scanned relative to the light irradiation means, even a large-sized substrate can be treated. Thus, a uniform and stable blue phase can be obtained.

In the above-described manner, a highly reliable liquid crystal display device which includes a liquid crystal layer exhibiting a stable blue phase can be manufactured. In addition, yield in manufacture is increased.

### Embodiment 3

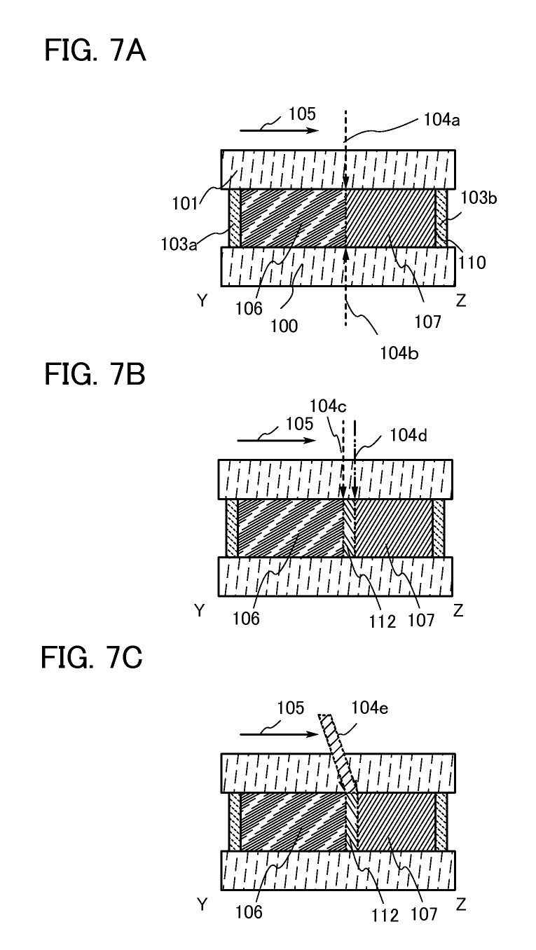

In this embodiment, another example of a light irradiation method that can be applied to Embodiment 1 or 2 will be described with reference to FIGS. 7A to 7C. Therefore, part of this embodiment can be performed in a manner similar to that of Embodiment 1 or 2; thus, repetitive description of the same portions as or portions having functions similar to those in Embodiment 1 or 2 and steps for forming such portions will be omitted. Note that a light shield is not illustrated in FIGS. 7A to 7C; however, when the first light irradiation treatment is performed, a light shield can be used.

FIGS. 7A to 7C each illustrate an example in which light irradiation treatment is selectively performed on a liquid crystal layer 110.

As illustrated in FIG. 7A, in the light irradiation treatment, a plurality of irradiation means may be provided so that not only one surface of the liquid crystal layer but both surfaces thereof are irradiated (both from the first substrate side and the second substrate side). A liquid crystal layer 110 is irradiated with light 104a which is delivered from the second substrate 101 side and with light 104b which is delivered from the first substrate 100 side. FIG. 7A illustrates an example in which the same region of the liquid crystal layer 110 is irradiated with the light 104a and the light 104b; however, different regions may be irradiated with the light 104a and the light 104b.

Alternatively, a plurality of lights supplying different energies may be used, and the liquid crystal layer may be irradiated with the plurality of lights in the order of increasing energy, starting from light which supplies the lowest energy to the liquid crystal layer. In FIG. 7B, light 104c and light 104d supply different energies, and the light 104d has lower energy than the light 104c. A region 112 which has been irradiated with the light 104d is irradiated with the light 104c; thus, a first region 106 is formed. In the case where plural kinds of the polymerizable monomer to be polymerized are used, when the energy and the timing of the irradiation lights are thus controlled, polymerization speed can also be controlled. Accordingly, stabilization treatment can be performed more uniformly.

In the light irradiation treatment, a surface of the liquid crystal layer may be irradiated from an oblique direction. In FIG. 7C, light 104e delivered to the liquid crystal layer 110 is obliquely incident on a surface of the liquid crystal layer 110, which makes a difference in energy supplied to the irradiation region. Accordingly, polymerization speed of the polymerizable monomer can be controlled in a manner similar to that of FIG. 7B.

In the above-described manner, by control of light irradiation conditions (timing of irradiation, energy of light, and irradiation time) and the like, polymer stabilization can be performed on the liquid crystal layer more uniformly.

The first light irradiation treatment and the second light irradiation treatment can be implemented in appropriate combination with the methods illustrated in FIGS. 7A to 7C.

As described above, the first light irradiation treatment and the second light irradiation treatment are performed, whereby a highly reliable liquid crystal display device which includes a liquid crystal layer exhibiting a stable blue phase can be manufactured. In addition, yield in manufacture is increased.

This embodiment can be implemented in appropriate combination with the structures described in the other embodiments.

### Embodiment 4

The invention disclosed in this specification can be applied to both a passive matrix liquid crystal display device and an active matrix liquid crystal display device.

A thin film transistor is manufactured, and a liquid crystal display device having a display function can be manufactured using the thin film transistor in a pixel portion and further in a driver circuit. Further, part or whole of a driver circuit including a thin film transistor can be formed over the same substrate as a pixel portion, whereby a system-on-panel can be obtained.

The liquid crystal display device includes a liquid crystal element (also referred to as a liquid crystal display element) as a display element.

Further, the liquid crystal display device includes a panel in which a display element is sealed, and a module in which an IC or the like including a controller is mounted to the panel. An embodiment of the present invention also relates to an element substrate, which corresponds to one embodiment before the display element is completed in a manufacturing process of the liquid crystal display device, and the element substrate is provided with means for supplying current to the display element in each of a plurality of pixels. Specifically, the element substrate may be in a state in which only a pixel electrode of the display element is formed, a state after a conductive film to be a pixel electrode is formed and before the conductive film is etched to form the pixel electrode, or any of other states.

Note that a liquid crystal display device in this specification means an image display device, a display device, or a light source (including a lighting device). Further, the liquid crystal display device includes any of the following modules in its category: a module to which a connector such as a flexible printed circuit (FPC), a tape automated bonding (TAB) tape, or a tape carrier package (TCP) is attached; a module having a TAB tape or a TCP at the tip of which a printed wiring board is provided; and a module in which an integrated circuit (IC) is directly mounted on a display element by chip on glass (COG) method.

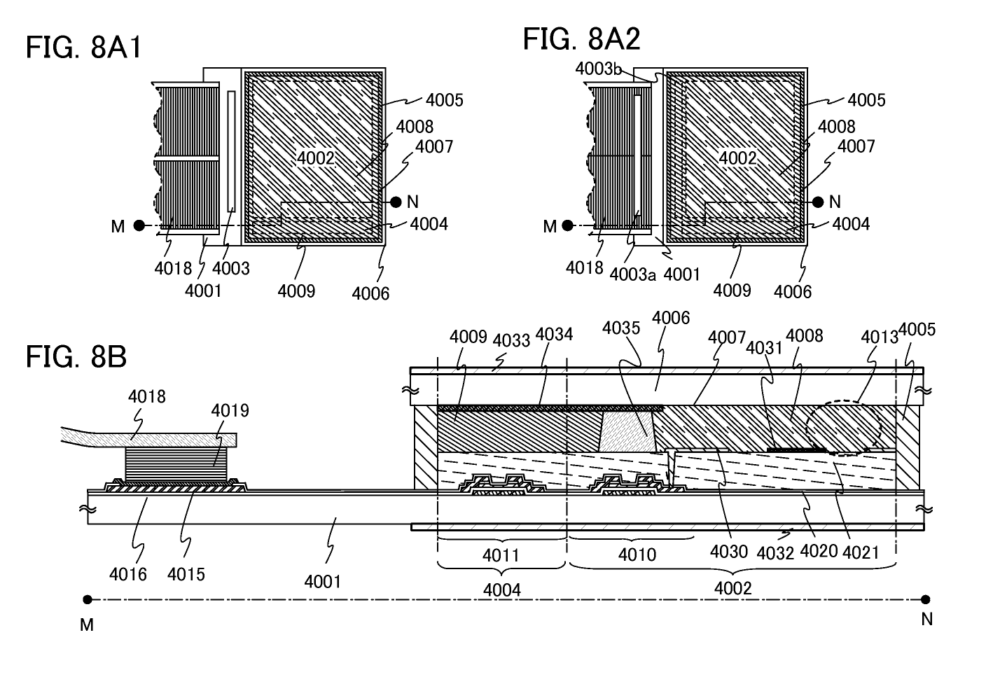

The appearance and a cross section of a liquid crystal display panel, which is one embodiment of the liquid crystal display device, will be described with reference to FIGS. 8A1, 8A2, and 8B. FIGS. 8A1 and 8A2 are top views of panels in which transistors 4010 and 4011 and a liquid crystal element 4013 which are formed over a first substrate 4001 are sealed between the first substrate 4001 and a second substrate 4006 with a sealant 4005. FIG. 8B is a cross-sectional view taken along line M-N in FIGS. 8A1 and 8A2.

The sealant 4005 is provided so as to surround a pixel portion 4002 and a scan line driver circuit 4004 which are provided over the first substrate 4001. The second substrate 4006 is provided over the pixel portion 4002 and the scan line driver circuit 4004. Therefore, the pixel portion 4002 and the scanning line driver circuit 4004 are sealed together with a liquid crystal layer 4007, by the first substrate 4001, the sealant 4005, and the second substrate 4006.

In FIG. 8A1, a signal line driver circuit 4003 that is formed using a single crystal semiconductor film or a polycrystalline semiconductor film over a substrate separately prepared is mounted in a region that is different from the region surrounded by the sealant 4005 over the first substrate 4001. Note that FIG. 8A2 illustrates an example in which part of the signal line driver circuit is formed using a thin film transistor provided over the first substrate 4001. A signal line driver circuit 4003b is formed over the first substrate 4001, and a signal line driver circuit 4003a formed using a single crystal semiconductor film or a polycrystalline semiconductor film is mounted over a separately-prepared substrate.

The liquid crystal layer 4007 in the pixel portion 4002 corresponds to a first region 4008 (which corresponds to the first region 108 illustrated in FIGS. 1A and 1B) where the polymerization of the polymerizable monomer is performed by light irradiation treatment as the polymer stabilization treatment, and the liquid crystal layer 4007 in the scanning line driver circuit 4004 and the signal line driver circuit 4003b corresponds to a second region 4009 (which corresponds to the second region 109 illustrated in FIGS. 1A and 1B). The first region 4008 in which a stable blue phase is formed serves as a display region, whereby a liquid crystal display device with improved display quality can be provided. Further, a region formed over the driver circuit which does not contribute to display in the vicinity of the sealant 4005 is the second region 4009. Therefore, even when alignment of the liquid crystal composition exhibiting a blue phase is disordered in the vicinity of the sealant, the display region is not affected, which is preferable.

Note that the connection method of a driver circuit which is separately formed is not particularly limited, and a COG method, a wire bonding method, a TAB method, or the like can be used. FIG. 8A1 illustrates an example of mounting the signal line driver circuit 4003 by a COG method, and FIG. 8A2 illustrates an example of mounting the signal line driver circuit 4003a by a TAB method.

The pixel portion 4002 and the scan line driver circuit 4004 provided over the first substrate 4001 include a plurality of thin film transistors. FIG. 8B illustrates the thin film transistor 4010 included in the pixel portion 4002 and the thin film transistor 4011 included in the scan line driver circuit 4004, as an example. An insulating layer 4020 and an interlayer film 4021 are provided over the thin film transistors 4010 and 4011.

A variety of thin film transistors can be applied to the thin film transistors 4010 and 4011 without particular limitation. In this embodiment, the thin film transistors 4010 and 4011 are n-channel thin film transistors.

A pixel electrode layer 4030 and a common electrode layer 4031 are provided on the side of the first substrate 4001, and the pixel electrode layer 4030 is electrically connected to the thin film transistor 4010. The liquid crystal element 4013 includes the pixel electrode layer 4030, a common electrode layer 4031, and the liquid crystal layer 4007. Note that a polarizing plate 4032 and a polarizing plate 4033 are provided on the outer sides of the first substrate 4001 and the second substrate 4006, respectively.

In a liquid crystal display device which includes a liquid crystal layer exhibiting a blue phase, method in which the gray scale is controlled by generating an electric field generally parallel (i.e., in a lateral direction) to a substrate to move liquid crystal molecules exhibiting a blue phase in a plane parallel to the substrate can be used. As such a method, an electrode structure used in an IPS mode illustrated in FIGS. 8A1, 8A2, and 8B is employed as an example in this embodiment.

As the first substrate 4001 and the second substrate 4006, glass, plastic, or the like having a light-transmitting property can be used. As plastic, a fiberglass-reinforced plastics (FRP) plate, a polyvinyl fluoride (PVF) film, a polyester film, or an acrylic resin film can be used. In addition, a sheet with a structure in which an aluminum foil is sandwiched between PVF films or polyester films can be used.

A columnar spacer denoted by reference numeral 4035 is obtained by selective etching of an insulating film and is provided in order to control the thickness (a cell gap) of the liquid crystal layer 4007. Alternatively, a spherical spacer may also be used. In the liquid crystal display device that uses the liquid crystal layer 4007, the thickness (the cell gap) of the liquid crystal layer 4007 is preferably about 4 μm to 20 μm.

Although FIGS. 8A1, 8A2, and 8B illustrate an example of a transmissive liquid crystal display device, an embodiment of the present invention can also be applied to a transflective liquid crystal display device.

FIGS. 8A1, 8A2, and 8B illustrate examples of liquid crystal display devices in each of which a polarizing plate is provided on the outer side (the viewing side) of the substrate; however, the polarizing plate may be provided on the inner side of the substrate. The position of the polarizing plate may be determined as appropriate depending on the material of the polarizing plate and conditions of the manufacturing process. Furthermore, a light-blocking layer serving as a black matrix may be provided.

The interlayer film 4021 is a light-transmitting chromatic-color resin layer and functions as a color filter layer. A light-blocking layer may be included in part of the interlayer film 4021. In FIG. 8B, a light-blocking layer 4034 is provided on the second substrate 4006 side to overlap with the thin film transistors 4010 and 4011. The light-blocking layer 4034 functions as a light shield for the second region 4009 in the light irradiation treatment which is polymer stabilization treatment. In addition, with the light-blocking layer 4034, contrast of the liquid crystal display device can be increased and the thin film transistors can be stabilized. In the case where the light-blocking layer 4034 is provided on the second substrate 4006, it is preferable that the first light irradiation treatment be performed by light irradiation from the second substrate 4006 side and the second light irradiation treatment be performed by light irradiation from the first substrate 4001 side.

The thin film transistors may be covered with the insulating layer 4020 which serves as a protective film of the thin film transistors; however, there is no particular limitation to such a structure.

Note that the protective film is provided to prevent entry of contaminant impurities such as organic substance, metal, or moisture existing in air and is preferably a dense film. The protective film may be formed with a single layer or a stacked layer of a silicon oxide film, a silicon nitride film, a silicon oxynitride film, a silicon nitride oxide film, an aluminum oxide film, an aluminum nitride film, aluminum oxynitride film, and/or an aluminum nitride oxide film by a sputtering method.

After the protective film is formed, the semiconductor layer may be subjected to heat treatment (300° C. to 400° C.).

In the case of further forming a light-transmitting insulating layer as a planarizing insulating film, the light-transmitting insulating layer can be formed using an organic material having heat resistance, such as polyimide, acrylic, benzocyclobutene, polyamide, or epoxy. In addition to such organic materials, it is also possible to use a low-dielectric constant material (a low-k material), a siloxane-based resin, PSG (phosphosilicate glass), BPSG (borophosphosilicate glass), or the like. The insulating layer may be formed by stacking a plurality of insulating films formed using these materials.

There is no particular limitation on the formation method of the insulating layer having a stacked structure, and any of the following can be employed depending on the material: methods such as sputtering, an SOG method, spin coating, dip coating, spray coating, and droplet discharging (e.g., ink jetting, screen printing, or offset printing); tools (equipment) such as doctor knife, roll coating, curtain coating, knife coating; and the like. In the case of forming the insulating layer using a material solution, heat treatment (200° C. to 400° C.) of the semiconductor layer may be performed at the same time as a baking step. The baking step of the insulating layer serves also as the heat treatment of the semiconductor layer, whereby a liquid crystal display device can be manufactured efficiently.

For an electrode layer (such as the pixel electrode layer 4030, the common electrode layer 4031, or the like) for applying voltage to the liquid crystal layer 4007, it is preferable that a conductive material having a light-transmitting property be used; however, a non-light-transmitting material such as a metal film may be used depending on a pattern of the electrode layer.

As the conductive material having a light-transmitting property, indium tin oxide, a conductive material in which zinc oxide (ZnO) is mixed in indium oxide, a conductive material in which silicon oxide (SiO₂) is mixed in indium oxide, organic indium, organotin, indium oxide containing tungsten oxide, indium zinc oxide containing tungsten oxide, indium oxide containing titanium oxide, or indium tin oxide containing titanium oxide, and the like can be given. As another conductive material, one kind or plural kinds selected from metal such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), or silver (Ag); an alloy thereof; and a nitride thereof can be used.

Further, the electrode layer can be formed using a conductive composition including a conductive high molecule (also referred to as a conductive polymer). The pixel electrode formed using the conductive composition preferably has a sheet resistance of less than or equal to 10000 ohms per square and a transmittance of greater than or equal to 70% at a wavelength of 550 nm. Further, the resistivity of the conductive high molecule included in the conductive composition is preferably less than or equal to 0.1 ohms·cm.

As the conductive macromolecule, a so-called π-electron conjugated conductive macromolecule can be used. For example, polyaniline and/or a derivative thereof, polypyrrole and/or a derivative thereof, polythiophene and/or a derivative thereof, and a copolymer of two or more of aniline, pyrrole, and thiophene and/or a derivative thereof can be given.

Further, a variety of signals and potentials are supplied to the signal line driver circuit 4003 which is formed separately, the scan line driver circuit 4004, or the pixel portion 4002 from an FPC 4018.

Since a thin film transistor is easily broken due to static electricity or the like, a protective circuit for protecting the driver circuit is preferably provided over the same substrate for a gate line or a source line. The protection circuit is preferably formed using a nonlinear element.

In FIGS. 8A1, 8A2, and 8B, a connecting terminal electrode 4015 is formed using the same conductive film as that of the pixel electrode layer 4030, and a terminal electrode 4016 is formed using the same conductive film as that of source and drain electrode layers of the thin film transistors 4010 and 4011.

The connection terminal electrode 4015 is electrically connected to a terminal included in the FPC 4018 via an anisotropic conductive film 4019.

Although, FIG. 8A1 illustrates the example in which the signal line driver circuit 4003 is formed separately and mounted on the first substrate 4001, and FIG. 8A2 illustrates the example in which the signal line driver circuit 4003a is formed separately and mounted on the FPC 4018, the present invention is not limited to this structure. The scan line driver circuit may be separately formed and then mounted, or only part of the signal line driver circuit or part of the scan line driver circuit may be separately formed and then mounted.

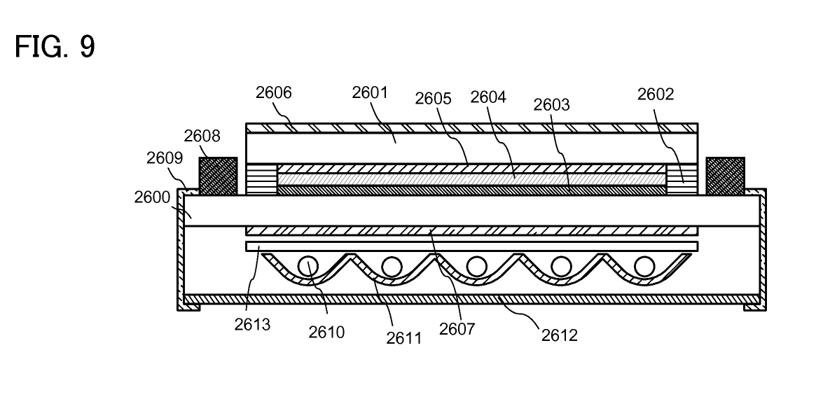

FIG. 9 illustrates an example of forming a liquid crystal display module as the liquid crystal display device disclosed in this specification.

FIG. 9 illustrates an example of a liquid crystal display module in which an element substrate 2600 and a counter substrate 2601 are bonded to each other with a sealant 2602, and an element layer 2603 including a TFT and the like, a display element 2604 including a liquid crystal layer, and a coloring layer 2605 functioning as a color filter are provided between the element substrate 2600 and the counter substrate 2601. The coloring layer 2605 which is a light-transmitting chromatic resin layer and is included in a display region is needed when color display is performed, and in the case of an RGB method, coloring layers corresponding to red, green, and blue are provided for respective pixels. The polarizing plates 2606 and 2607 and a diffuser plate 2613 are provided on an outer side of the counter substrate 2601 and the element substrate 2600. A light source includes a cold cathode tube 2610 and a reflective plate 2611, and a circuit substrate 2612 is connected to a wiring circuit portion 2608 of the element substrate 2600 through a flexible wiring board 2609 and includes an external circuit such as a control circuit and a power source circuit. As the light source, a white diode may be used. The polarizing plate and the liquid crystal layer may be stacked with a retardation plate therebetween.

Through the above process, a highly reliable liquid crystal display panel as a liquid crystal display device can be manufactured.

This embodiment can be implemented in appropriate combination with the structures described in the other embodiments.

### Embodiment 5

There is no particular limitation on the semiconductor material used for the semiconductor layer of the thin film transistor included in the liquid crystal display device disclosed in this specification. An example of a material which can be used for the semiconductor layer of the thin film transistor will be described.

A semiconductor layer included in a semiconductor element can be formed using any of the following materials: an amorphous semiconductor (hereinafter also referred to as an “AS”) formed by a vapor deposition method using a semiconductor material gas typified by silane or germane or by a sputtering method; a polycrystalline semiconductor formed by crystallizing the amorphous semiconductor by utilizing light energy or thermal energy; a microcrystalline (also referred to as semiamorphous) semiconductor (hereinafter also referred to as a “SAS”); and the like. The semiconductor layer can be deposited by a sputtering method, an LPCVD method, a plasma CVD method, or the like.

The microcrystalline semiconductor film has a metastable state of an intermediate between an amorphous structure and a single crystal structure when Gibbs free energy is considered. That is, the microcrystalline semiconductor film is a semiconductor having a third state which is stable in terms of free energy and has a short range order and lattice distortion. Columnar-like or needle-like crystals grow in a normal direction with respect to a substrate surface. The Raman spectrum of microcrystalline silicon, which is a typical example of a microcrystalline semiconductor, is located in a lower wave number side than 520 cm⁻¹, which represents single crystal silicon. That is, the peak of the Raman spectrum of the microcrystalline silicon exists between 520 cm⁻¹ which represents single crystal silicon and 480 cm⁻¹ which represents amorphous silicon. In addition, microcrystalline silicon contains hydrogen or halogen of at least 1 atomic percent or more in order to terminate a dangling bond. Moreover, microcrystalline silicon contains a rare gas element such as helium, argon, krypton, or neon to further promote lattice distortion, so that stability is increased and a favorable microcrystalline semiconductor can be obtained.

This microcrystalline semiconductor film can be formed by a high-frequency plasma CVD method with a frequency of higher than or equal to several tens of megahertz and lower than or equal to several hundreds of megahertz or a microwave plasma CVD method with a frequency of 1 GHz or higher. The microcrystalline semiconductor film can be typically formed using a dilution of silicon hydride such as SiH₄, Si₂H₆, SiH₂Cl₂, SiHCl₃, SiCl₄, or SiF₄ with hydrogen. Alternatively, the microcrystalline semiconductor film can be formed using a gas containing a silicon hydride and hydrogen which is diluted with one or more rare gas elements selected from helium, argon, krypton, and neon. In that case, the flow ratio of hydrogen to silicon hydride is 5:1 to 200:1, preferably 50:1 to 150:1, more preferably 100:1.

A typical example of an amorphous semiconductor is hydrogenated amorphous silicon, while a typical example of a crystalline semiconductor is polysilicon and the like. Polysilicon (polycrystalline silicon) includes so-called high-temperature polysilicon that contains polysilicon formed at a process temperature of higher than or equal to 800° C. as its main component, so-called low-temperature polysilicon that contains polysilicon formed at a process temperature of lower than or equal to 600° C. as its main component, polysilicon formed by crystallizing amorphous silicon by using an element that promotes crystallization, or the like, and the like. Needless to say, as described above, a microcrystalline semiconductor, or a semiconductor which includes a crystalline phase in part of a semiconductor layer can be used.

In addition, as a material for the semiconductor, a compound semiconductor such as GaAs, InP, SiC, ZnSe, GaN, or SiGe can be used as well as an element such as silicon (Si) or germanium (Ge).

In the case of using a crystalline semiconductor film for the semiconductor layer, the crystalline semiconductor film may be formed by various methods (such as a laser crystallization method, a thermal crystallization method, or a thermal crystallization method using an element that promotes crystallization, such as nickel). Further, when a microcrystalline semiconductor that is SAS is crystallized by laser irradiation, crystallinity thereof can be enhanced. In the case where an element which promotes crystallization is not used, before an amorphous silicon film is irradiated with a laser light, the amorphous silicon film is heated at 500° C. for one hour in a nitrogen atmosphere so that the concentration of hydrogen contained in the amorphous silicon film becomes less than or equal to 1×10²⁰ atoms/cm³. This is because, if the amorphous silicon film contains much hydrogen, the amorphous silicon film would be destroyed by laser irradiation.

There is no particular limitation on the method of adding a metal element into the amorphous semiconductor film as long as the metal element can exist in the surface of or inside the amorphous semiconductor film. For example, a sputtering method, a CVD method, a plasma treatment method (e.g., a plasma CVD method), an adsorption method, or a method of applying a metal salt solution can be used. Among them, the method using a solution is simple and advantageous in that the concentration of the metal element can be easily controlled. At this time, an oxide film is preferably formed on the surface of the amorphous semiconductor film by UV light irradiation in an oxygen atmosphere, thermal oxidation, treatment with ozone-containing water or hydrogen peroxide including a hydroxyl radical, or the like in order to improve its wettability and to spread the solution over the entire surface of the amorphous semiconductor film.

In a crystallization step in which an amorphous semiconductor film is crystallized to form a crystalline semiconductor film, an element which promotes crystallization (also referred to as a catalytic element or a metal element) may be added to the amorphous semiconductor film, and crystallization may be performed by heat treatment (at 550° C. to 750° C. for 3 minutes to 24 hours). As the element which promotes (accelerates) the crystallization, one or more of iron (Fe), nickel (Ni), cobalt (Co), ruthenium (Ru), rhodium (Rh), palladium (Pd), osmium (Os), iridium (Ir), platinum (Pt), copper (Cu), and gold (Au) can be used.

In order to remove or reduce the element that promotes crystallization from the crystalline semiconductor film, a semiconductor film containing an impurity element is formed in contact with the crystalline semiconductor film so as to function as a gettering sink. As the impurity element, an impurity element which imparts n-type conductivity, an impurity element which imparts p-type conductivity, a rare gas element, or the like can be used. For example, one or more elements selected from phosphorus (P), nitrogen (N), arsenic (As), antimony (Sb), bismuth (Bi), boron (B), helium (He), neon (Ne), argon (Ar), krypton (Kr), and xenon (Xe) can be used. A semiconductor film containing the rare gas element is formed on the crystalline semiconductor film containing the element that promotes crystallization, and then heat treatment is performed (at 550° C. to 750° C. for 3 minutes to 24 hours). The element which promotes crystallization contained in the crystalline semiconductor film moves into the semiconductor film containing the rare gas element, and thus, the element which promotes crystallization contained in the crystalline semiconductor film is removed or reduced. After that, the semiconductor film containing the rare gas element, which serves as the gettering sink, is removed.

The amorphous semiconductor film may be crystallized by a combination of heat treatment and laser light irradiation, or several times of either heat treatment or laser light irradiation.

A crystalline semiconductor film can also be formed directly over the substrate by a plasma method. Alternatively, a crystalline semiconductor film may be selectively formed over the substrate by a plasma method.

An oxide semiconductor may be used for the semiconductor layer. For example, zinc oxide (ZnO), tin oxide (SnO₂), or the like can be used. In the case of using ZnO for the semiconductor layer, Y₂O₃, Al₂O₃, TiO₂, a stacked layer thereof, or the like can be used for a gate insulating layer, and ITO, Au, Ti, or the like can be used for a gate electrode layer, a source electrode layer, and a drain electrode layer. In addition, In, Ga, or the like can be added to ZnO.

As the oxide semiconductor, a thin film expressed by InMO₃(ZnO)ₘ (m>0) can be used. Note that M denotes one or more of metal elements selected from gallium (Ga), iron (Fe), nickel (Ni), manganese (Mn), and cobalt (Co). For example, M is gallium (Ga) in some cases, and in other cases, M contains other metal elements in addition to Ga, such as Ga and Ni or Ga and Fe. Further, the above oxide semiconductor may contain Fe or Ni, another transitional metal element, or an oxide of the transitional metal as an impurity element in addition to the metal element contained as M. For example, an In—Ga—Zn—O-based non-single-crystal film can be used for an oxide semiconductor layer.

As the oxide semiconductor layer (the InMO₃(ZnO)ₘ (m>0) film), an InMO₃(ZnO)ₘ film (m>0) in which M is another metal element may be used instead of the In—Ga—Zn—O-based non-single-crystal film.

This embodiment can be implemented in appropriate combination with the structures described in the other embodiments.

### Embodiment 6

The liquid crystal display device disclosed in this specification can be applied to a variety of electronic appliances (including game machines). Examples of electronic appliances are a television set (also referred to as a television or a television receiver), a monitor of a computer or the like, a camera such as a digital camera or a digital video camera, a digital photo frame, a mobile phone handset (also referred to as a mobile phone or a mobile phone device), a portable game console, a portable information terminal, an audio reproducing device, a large-sized game machine such as a pachinko machine, and the like.

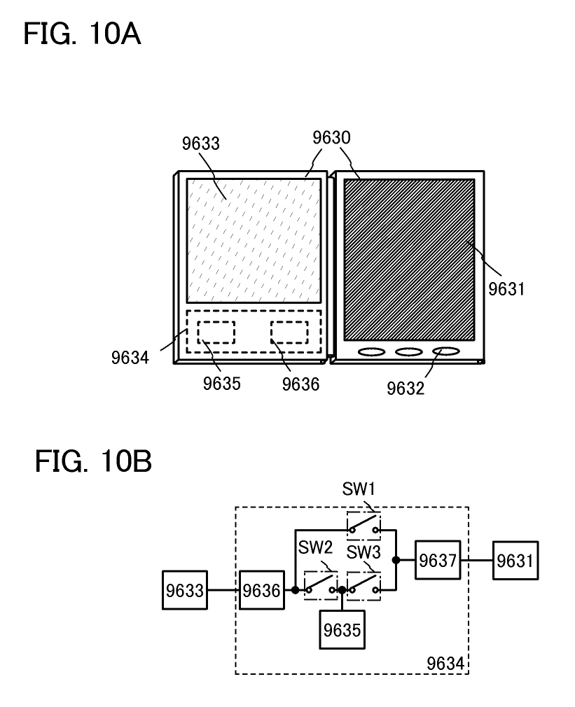

FIG. 10A illustrates an electronic book reader (also referred to as an e-book reader) which can include housings 9630, a display portion 9631, operation keys 9632, a solar cell 9633, and a charge and discharge control circuit 9634. The electronic book reader illustrated in FIG. 10A has a function of displaying various kinds of information (e.g., a still image, a moving image, and a text image) on the display portion, a function of displaying a calendar, a date, the time, or the like on the display portion, a function of operating or editing the data displayed on the display portion, a function of controlling processing by various kinds of software (programs), and the like. In FIG. 10A, a structure including a battery 9635 and a DCDC converter (hereinafter abbreviated as a converter) 9636 is illustrated as an example of the charge and discharge control circuit 9634. The liquid crystal display device described in any of the above embodiments can be applied to the display portion 9631, whereby a highly reliable electronic book reader with improved display quality can be obtained.

In the case where a transflective liquid crystal display device or a reflective liquid crystal display device is used as the display portion 9631, use under a relatively bright condition is assumed; therefore, the structure illustrated in FIG. 10A is preferable because power generation by the solar cell 9633 and charge with the battery 9635 are effectively performed. Since the solar cell 9633 can be provided on a space (a surface or a rear surface) of the housing 9630 as appropriate, the battery 9635 can be efficiently charged, which is preferable. When a lithium ion battery is used as the battery 9635, there is an advantage of downsizing or the like.

The structure and the operation of the charge and discharge control circuit 9634 illustrated in FIG. 10A are described with reference to a block diagram in FIG. 10B. The solar cell 9633, the battery 9635, the converter 9636, the converter 9637, switches SW1 to SW3, and the display portion 9631 are shown in FIG. 10B, and the battery 9635, the converter 9636, the converter 9637, and the switches SW1 to SW3 correspond to the charge and discharge control circuit 9634.

First, an example of operation in the case where power is generated by the solar cell 9633 using external light is described. The voltage of power generated by the solar cell is raised or lowered by the converter 9636 so that the power has a voltage for charging the battery 9635. Then, when the power from the solar cell 9633 is used for the operation of the display portion 9631, the switch SW1 is turned on and the voltage of the power is raised or lowered by the converter 9637 so as to be a voltage needed for the display portion 9631. In addition, when display on the display portion 9631 is not performed, the switch SW1 is turned off and the switch SW2 is turned on so that charge of the battery 9635 may be performed.

Next, an example of operation in the case where power is not generated by the solar cell 9633 using external light is described. The voltage of power accumulated in the battery 9635 is raised or lowered by the converter 9637 by turning on the switch SW3. Then, power from the battery 9635 is used for the operation of the display portion 9631.

Note that although the solar cell 9633 is described as an example of a means for charge, charge of the battery 9635 may be performed with another means. In addition, a combination of the solar cell 9633 and another means for charge may be used.

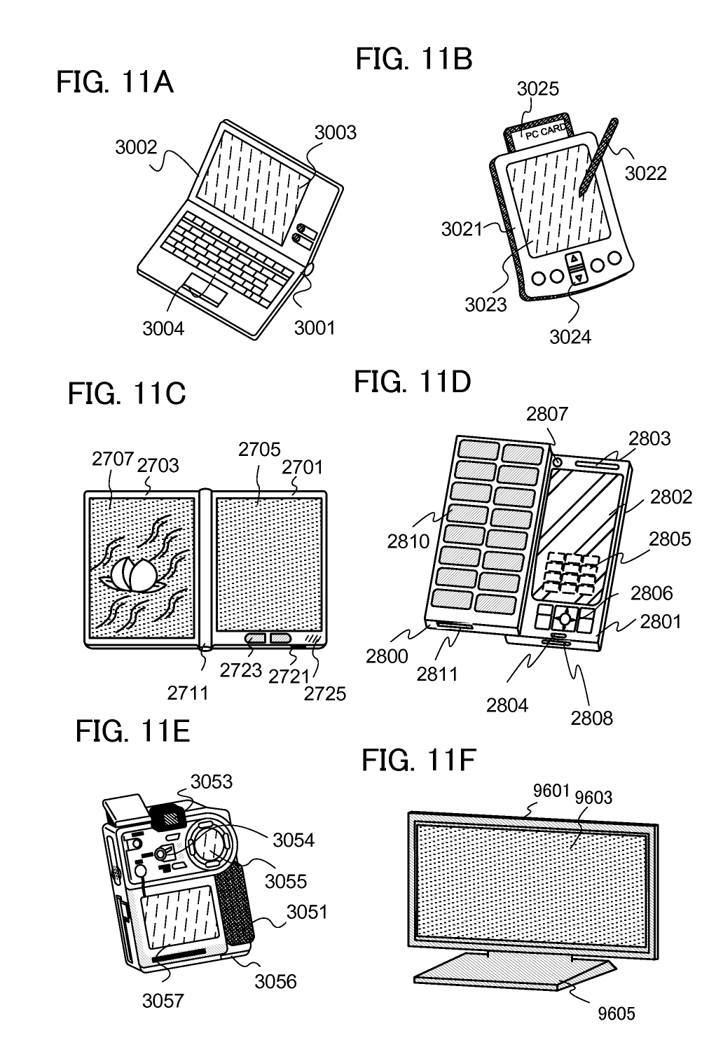

FIG. 11A illustrates a laptop personal computer, which includes a main body 3001, a housing 3002, a display portion 3003, a keyboard 3004, and the like. By applying the liquid crystal display device described in any of the above embodiments to the display portion 3003, a highly reliable laptop personal computer with improved display quality can be obtained.

FIG. 11B is a personal digital assistant (PDA), which includes a main body 3021 provided with a display portion 3023, an external interface 3025, operation buttons 3024, and the like. A stylus 3022 is included as an accessory for operation. By applying the liquid crystal display device described in any of the above embodiments to the display portion 3023, a highly reliable personal digital assistant (PDA) with improved display quality can be obtained.

FIG. 11C illustrates an e-book reader, which includes two housings, a housing 2701 and a housing 2703. The housing 2701 and the housing 2703 are combined with a hinge 2711 so that the e-book reader 2700 can be opened and closed with the hinge 2711 as an axis. With such a structure, the e-book reader 2700 can operate like a paper book.

A display portion 2705 and a display portion 2707 are incorporated in the housing 2701 and the housing 2703, respectively. The display portion 2705 and the display portion 2707 may display one image or different images. In the structure where different images are displayed on different display portions, for example, the right display portion (the display portion 2705 in FIG. 11C) can display text and the left display portion (the display portion 2707 in FIG. 11C) can display graphics. By applying the liquid crystal display device described in any of the above embodiments to the display portions 2705 and 2707, a highly reliable e-book reader with improved display quality can be obtained.

FIG. 11C illustrates an example in which the housing 2701 is provided with an operation portion and the like. For example, the housing 2701 is provided with a power switch 2721, an operation key 2723, a speaker 2725, and the like. With the operation key 2723, pages can be turned. Note that a keyboard, a pointing device, or the like may also be provided on the surface of the housing, on which the display portion is provided. Furthermore, an external connection terminal (an earphone terminal, a USB terminal, or the like), a recording medium insertion portion, and the like may be provided on the back surface or the side surface of the housing. Further, the e-book reader may have a function of an electronic dictionary.

The e-book reader may transmit and receive data wirelessly. Through wireless communication, desired book data or the like can be purchased and downloaded from an electronic book server.

FIG. 11D illustrates a mobile phone, which includes two housings, a housing 2800 and a housing 2801. The housing 2801 includes a display panel 2802, a speaker 2803, a microphone 2804, a pointing device 2806, a camera lens 2807, an external connection terminal 2808, and the like. In addition, the housing 2800 includes a solar cell 2810 having a function of charge of the portable information terminal, an external memory slot 2811, and the like. Further, an antenna is incorporated in the housing 2801. By applying the liquid crystal display described in any of the above embodiments to the display panel 2802, a highly reliable mobile phone with improved display quality can be obtained.

The display panel 2802 is provided with a touch panel. A plurality of operation keys 2805 which is displayed as images is illustrated by dashed lines in FIG. 11D. Note that a boosting circuit by which a voltage output from the solar cell 2810 is increased to be sufficiently high for each circuit is also included.

In the display panel 2802, the display direction can be appropriately changed depending on a usage pattern. Further, the mobile phone is provided with the camera lens 2807 on the same surface as the display panel 2802, and thus it can be used as a video phone. The speaker 2803 and the microphone 2804 can be used for videophone calls, recording and playing sound, and the like as well as voice calls. Moreover, the housings 2800 and 2801 in a state where they are developed as illustrated in FIG. 11D can shift by sliding so that one is lapped over the other; therefore, the size of the mobile phone can be reduced, which makes the mobile phone suitable for being carried.

The external connection terminal 2808 can be connected to an AC adapter and various types of cables such as a USB cable, and charging and data communication with a personal computer are possible. Moreover, a large amount of data can be stored by inserting a storage medium into the external memory slot 2811 and can be moved.

Further, in addition to the above functions, an infrared communication function, a television reception function, or the like may be provided.

FIG. 11E illustrates a digital video camera which includes a main body 3051, a display portion A 3057, an eyepiece portion 3053, an operation switch 3054, a display portion B 3055, a battery 3056, and the like. By applying the liquid crystal display device described in any of the above embodiments to the display portion A 3057 and the display portion B 3055, a highly reliable digital video camera with improved display quality can be obtained.

FIG. 11F illustrates a television set in which a display portion 9603 and the like are incorporated in a housing 9601. The display portion 9603 can display images. Here, the housing 9601 is supported by a stand 9605. By applying the liquid crystal display device described in any of the above embodiments to the display portion 9603, a highly reliable television set with improved display quality can be obtained.

The television set can be operated by an operation switch of the housing 9601 or a separate remote controller. Further, the remote controller may be provided with a display portion for displaying data output from the remote controller.

Note that the television set is provided with a receiver, a modem, and the like. With the use of the receiver, general television broadcasting can be received. Moreover, when the television set is connected to a communication network with or without wires via the modem, one-way (from a sender to a receiver) or two-way (between a sender and a receiver or between receivers) information communication can be performed.

This embodiment can be implemented in appropriate combination with the structures described in the other embodiments.

### Example

In this example, a case where a liquid crystal display device is manufactured using a method for manufacturing a liquid crystal display device according to one embodiment of the present invention will be described.

First, a method for manufacturing Sample 1 of this example will be described.

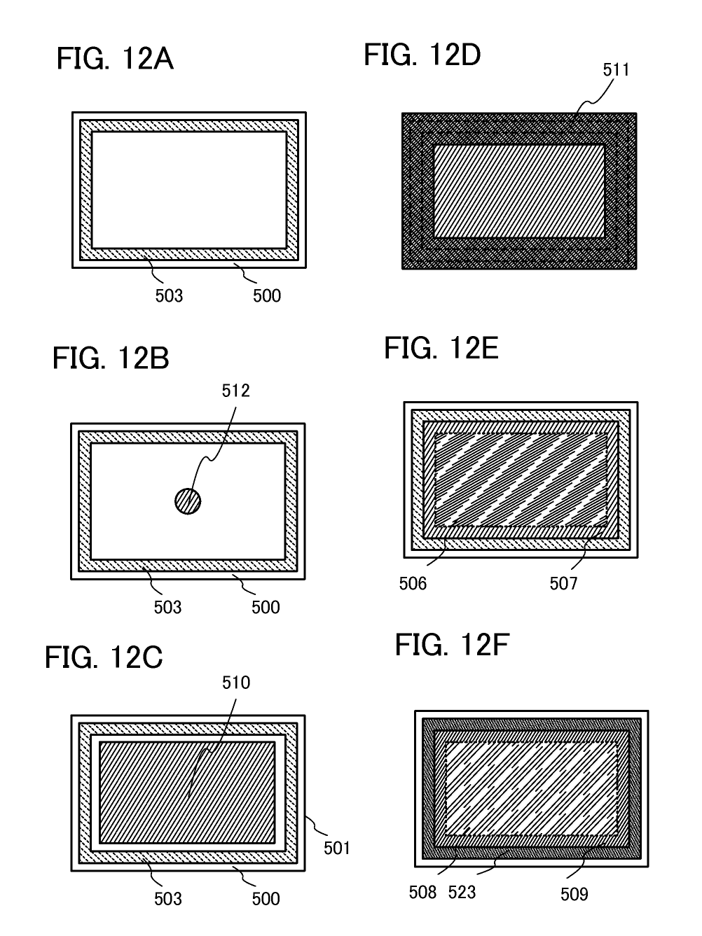

First, spacers each having a diameter of 4 μm were dispersed over a 5-inch glass substrate 500 (EAGLE XG manufactured by Corning Incorporated), and then a photocurable and thermosetting sealant 503 was formed (see FIG. 12A). The photocurable and thermosetting sealant 503 was formed to have a rectangular shape of 4 cm by 3 cm.

The photocurable and thermosetting sealant 503 was formed using a resin which has a viscosity of 300 Pa·sec (at 25° C.) and includes an acrylic-based resin, an epoxy-based resin, an ultraviolet light polymerization initiator, a thermosetting agent, or a coupling agent.

Next, a liquid crystal material 512 was dropped on the inner side than the sealant 503 over the glass substrate 500 (see FIG. 12B). The liquid crystal material 512 includes 84.9 wt % of a liquid crystal material exhibiting a blue phase, 6.9 wt % of a chiral agent, 4.0 wt % of dodecyl methylacrylate (abbreviated as DMeAc and produced by Tokyo Chemical Industry Co., Ltd.) and 4.0 wt % of RM257 (produced by Merck Ltd.) as polymerizable monomers, and 0.2 wt % of DMPAP (which is an abbreviation and produced by Tokyo Chemical Industry Co., Ltd.) as a polymerization initiator.

In this case, the temperature of the liquid crystal material 512 was set to 70° C. at which the liquid crystal material exhibits an isotropic phase, and about 14 mg of the liquid crystal material was dropped on the inner side than the sealant 503.

Then, a glass substrate 501 (EAGLE XG manufactured by Corning Incorporated) was attached to the glass substrate 500. Here, the glass substrate 501 was fixed to an upper side of a chamber with an electrostatic chuck, and the glass substrate 500 on which the liquid crystal material 512 was dropped was placed on a lower side of the chamber. Then, the pressure inside the chamber was reduced to 100 Pa, and the glass substrate 500 and the glass substrate 501 were bonded to each other. After that, the chamber was exposed to the atmosphere.

The distance between the glass substrate 500 and the glass substrate 501 was approximately 4 μm at this time. The liquid crystal material 512 spread over approximately 90 percent of a surface on the inner side than the sealant 503, and a liquid crystal layer 510 was formed (see FIG. 12C).

Next, a light shield 511 with a light-blocking property was provided to cover the sealant 503 and a region of the liquid crystal layer 510 in the vicinity of the sealant 503 (see FIG. 12D).

Next, the liquid crystal layer 510 was heated to 70° C. and the liquid crystal layer 510 spread over the entire surface on the inner side than the sealant 503. After that, the temperature was decreased by one degree per minute from 50° C. in order that a phase may transfer from an isotropic phase to a blue phase, and then irradiation with ultraviolet rays (1.5 mW/cm²) with a main wavelength of 365 nm was performed for 30 minutes as a first light irradiation treatment while the temperature was kept at 36° C. at which the blue phase spreads over the entire surface (see FIG. 12E). Further, by the first light irradiation treatment, in the liquid crystal layer 510, a first region 506 was formed as a region where polymerization of the polymerizable monomer was performed and a second region 507 covered with the light shield 511 was formed.

Next, the light shield 511 was removed and then irradiation with ultraviolet rays (1.5 mW/cm²) with a main wavelength of 365 nm was performed on the sealant 503 and an entire region of the liquid crystal layer 510 for 30 minutes as a second light irradiation treatment. By the second light irradiation treatment, the first region 506 became a first region 508 with an enhanced polymerization property and the second region 507 became a second region 509 where the polymerizable monomer was polymerized. Further, the sealant 503 was cured by irradiation with light.

Next, heat treatment was performed to post-cure the photocurable and thermosetting sealant 503. As a result, a post-cured sealant 523 was obtained. After that, the glass substrate 500 and the glass substrate 501 were cut and the separated panels were each provided with an FPC or the like, whereby a liquid crystal display device (Sample 1 of this example) was manufactured.

Next, a method for manufacturing Comparative Sample 1 will be described.

Comparative Sample 1 was formed in a manner similar to Sample 1 of this example except for the following point. In FIG. 12D, irradiation with ultraviolet rays (1.5 mW/cm²) with a main wavelength of 365 nm was performed on the sealant 503 and the entire region of the liquid crystal layer 510 without the light shield 511 for 30 minutes as the light irradiation treatment and the second light irradiation treatment was not performed.

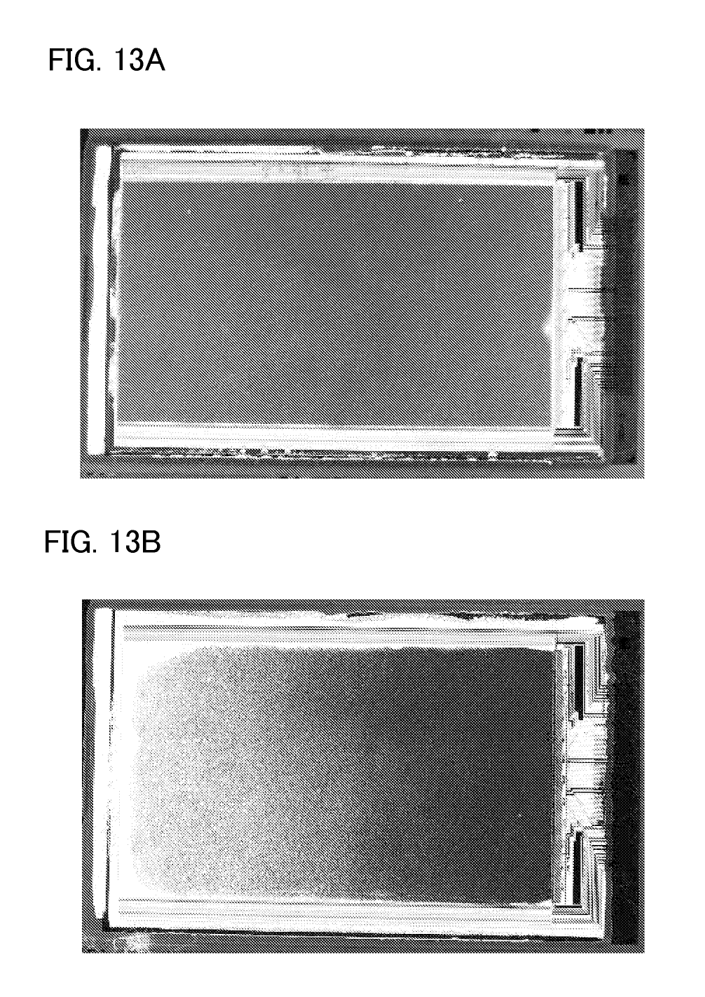

FIGS. 13A and 13B are each a photograph showing an appearance of an FPC in a state just after attachment. FIG. 13A is a photograph showing an appearance of Sample 1 of this example and FIG. 13B is a photograph showing an appearance of Comparative Sample 1.

As shown in FIG. 13B, in Comparative Sample 1 in which the light irradiation treatment was performed on the sealant 503 and the entire region of the liquid crystal layer 510 only once, it was confirmed that a display defect was caused by alignment disorder of the liquid crystal composition in the entire liquid crystal layer. Meanwhile, as shown in FIG. 13A, in Sample 1 of this example on which the two-step light irradiation treatment was performed, it was not confirmed that a display defect was caused by alignment disorder of the liquid crystal composition.

The above results suggest that a highly reliable liquid crystal display device with improved display quality can be manufactured with the use of a method for manufacturing a liquid crystal display device according to one embodiment of the present invention.

This application is based on Japanese Patent Application serial no. 2010-267309 filed with Japan Patent Office on Nov. 30, 2010, the entire contents of which are hereby incorporated by reference.

What is claimed is:

1. A method for manufacturing a liquid crystal display device comprising:
bonding a first substrate and a second substrate to each other by a sealant with a liquid crystal layer interposed between the first substrate and the second substrate, wherein the liquid crystal layer comprises a polymerizable monomer and a liquid crystal composition, and the liquid crystal composition is capable of exhibiting a blue phase;
covering the sealant and a second region of the liquid crystal layer with a light shield;
performing a first light irradiation treatment on a first region of the liquid crystal layer with use of the light shield as a mask;
removing the light shield; and
performing a second light irradiation treatment on the first region and the second region of the liquid crystal layer after the removing,
wherein the second region has a lower degree of polymerization of the polymerizable monomer than the first region.

2. The method for manufacturing a liquid crystal display device, according to claim 1, wherein an ultraviolet curable resin or a photocurable and thermosetting resin is used for the sealant.

3. The method for manufacturing a liquid crystal display device, according to claim 2, wherein one or more of an acrylic-based resin, an epoxy-based resin, or an amine resin is used for the ultraviolet curable resin or the photocurable and thermosetting resin.

4. The method for manufacturing a liquid crystal display device, according to claim 1, wherein a display region is formed in the first region.

5. The method for manufacturing a liquid crystal display device, according to claim 1, wherein the second light irradiation treatment is performed on the sealant.

6. A method for manufacturing a liquid crystal display device comprising:
bonding a first substrate and a second substrate to each other by a sealant with a liquid crystal layer interposed between the first substrate and the second substrate, wherein the liquid crystal layer comprises a polymerizable monomer and a liquid crystal composition, and the liquid crystal composition is capable of exhibiting a blue phase;
covering the sealant and a second region of the liquid crystal layer with a first light shield;
performing a first light irradiation treatment on a first region of the liquid crystal layer with use of the first light shield as a mask;
removing the first light shield; and
covering the first region with a second light shield after the removing; and
performing a second light irradiation treatment on the second region of the liquid crystal layer with use of the second light shield as a mask,
wherein the second region has a lower degree of polymerization of the polymerizable monomer than the first region.

7. The method for manufacturing a liquid crystal display device, according to claim 6, wherein an ultraviolet curable resin or a photocurable and thermosetting resin is used for the sealant.

8. The method for manufacturing a liquid crystal display device, according to claim 7, wherein one or more of an acrylic-based resin, an epoxy-based resin, or an amine resin is used for the ultraviolet curable resin or the photocurable and thermosetting resin.

9. The method for manufacturing a liquid crystal display device, according to claim 6, wherein a display region is formed in the first region.

10. The method for manufacturing a liquid crystal display device, according to claim 9, wherein the second light irradiation treatment is performed on the sealant.

11. A method for manufacturing a liquid crystal display device comprising:
forming a light shield in a peripheral portion of one of a first substrate and a second substrate;
bonding the first substrate and the second substrate to each other by a sealant with a liquid crystal layer interposed between the first substrate and the second substrate to cover the sealant and a second region of the liquid crystal layer with the light shield, wherein the liquid crystal layer comprises a polymerizable monomer and a liquid crystal composition, and the liquid crystal composition is capable of exhibiting a blue phase;
performing a first light irradiation treatment on a first region of the liquid crystal layer from the one of the first substrate side and the second substrate side; and
performing a second light irradiation treatment on the first region and the second region of the liquid crystal layer from the other of the first substrate side and the second substrate side,
wherein the second region has a lower degree of polymerization of the polymerizable monomer than the first region.

12. The method for manufacturing a liquid crystal display device, according to claim 11, wherein an ultraviolet curable resin or a photocurable and thermosetting resin is used for the sealant.

13. The method for manufacturing a liquid crystal display device, according to claim 12, wherein one or more of an acrylic-based resin, an epoxy-based resin, or an amine resin is used for the ultraviolet curable resin or the photocurable and thermosetting resin.

14. The method for manufacturing a liquid crystal display device, according to claim 11, wherein a display region is formed in the first region.

15. The method for manufacturing a liquid crystal display device, according to claim 11, wherein the second light irradiation treatment is performed on the sealant.

16. A method for manufacturing a liquid crystal display device comprising:
bonding a first substrate and a second substrate to each other by a sealant with a liquid crystal layer interposed between the first substrate and the second substrate, wherein the liquid crystal layer comprises a polymerizable monomer and a liquid crystal composition, and the liquid crystal composition is capable of exhibiting a blue phase;
selectively performing a first light irradiation treatment on a first region of the liquid crystal layer while a second region of the liquid crystal layer is not treated with the first light irradiation treatment; and
performing a second light irradiation treatment on the first region and the second region of the liquid crystal layer after the removing,
wherein the second region has a lower degree of polymerization of the polymerizable monomer than the first region.

17. The method for manufacturing a liquid crystal display device, according to claim 16, wherein an ultraviolet curable resin or a photocurable and thermosetting resin is used for the sealant.

18. The method for manufacturing a liquid crystal display device, according to claim 17, wherein one or more of an acrylic-based resin, an epoxy-based resin, or an amine resin is used for the ultraviolet curable resin or the photocurable and thermosetting resin.

19. The method for manufacturing a liquid crystal display device, according to claim 16, wherein a display region is formed in the first region.

20. The method for manufacturing a liquid crystal display device, according to claim 16, wherein the second light irradiation treatment is performed on the sealant.
